(19) United States
(12) Patent Application Publication
(10) Pub. No.: US 2003/0228199 A1
(43) Pub. Date: Dec. 11, 2003

(54) Tool holder

(75) Inventors: Masakazu Matsumoto, Osaka-shi (JP); Masahiro Taguchi, Osaka-shi (JP); Kazuhiro Shimono, Osaka-shi (JP)

Correspondence Address: Richard P. Berg, LADAS & PARRY, Suite # 2100, 5670 Wilshire Boulevard, Los Angeles, CA, 90036-5679, US

(73) Assignee: Nikken Kosakusho Works Ltd.

(21) Appl. No.: 10/453,271

(22) Filed: Jun. 3, 2003

(30) Foreign Application Priority Data
Jun. 10, 2002 (JP) 2002-168336
Nov. 7, 2002 (JP) 2002-323624

(51) Int. Cl. B23B 31/02

(52) U.S. Cl. 409/141; 408/143

(57) ABSTRACT

A tool holder includes a holder body which in turn includes a flange portion. A plurality of threaded holes are formed in the flange portion. A weight balance adjustment member(s) is removably screwed into an appropriate threaded hole(s). The adjustment member includes a coming-out prevention mechanism for preventing the same from coming out of the threaded hole. In another tool holder, weight balance adjustment members are removably screwed into all the threaded holes, each of the adjustment members includes a coming-out prevention mechanism for preventing the same from coming out of the threaded hole, and a detachment prevention member is provided on the outer circumferential surface of the flange portion in order to prevent detachment of the adjustment members.

### BACKGROUND OF THE INVENTION

1. Field of the Invention

The present invention relates to a tool holder to be attached to a spindle of a machine tool. More particularly, the invention relates to a tool holder which allows adjustment of its rotational weight balance associated with rotation about its axis.

2. Description of the Related Art

When a machine tool such as a machining center is used to cut a workpiece by means of a cutting tool such as a drill or an end mill, vibration of a tool holder including the cutting tool has an adverse effect on accuracy in machining the workpiece. A cause for this vibration is forced vibration induced by rotational imbalance of the tool holder.

A conventional tool holder which allows adjustment of its rotational imbalance is disclosed, for example, in Japanese Utility Model Registration No. 2512454.

FIGS. 1 and 2 show a conventional tool holder having such a balance adjustment mechanism. A tool holder 1 includes a tapered shank portion 2 to be attached to an unillustrated spindle of a machine tool; a flange portion 3 formed at a large-diameter end of the shank portion 2 and serving as a grip; and an arbor 4 formed integrally and coaxially on a side of the flange portion 3 opposite the shank portion 2. A cutting tool (not shown) such as a drill is attached to an end portion of the arbor 4 by means of an unillustrated collet chuck.

A plurality of threaded holes 5 are formed at predetermined circumferential intervals on an end surface 3a of the flange portion 3 located on the side toward the arbor 4. An adjustment weight(s) 6 is removably screwed into an appropriate threaded hole(s) 5 for adjusting dynamic weight balance of the tool holder 1 associated with rotation of the tool holder 1 about its axis.

However, in the conventional tool holder 1, an adjustment weight(s) 6 is attached to the flange portion 3 such that the screw-type adjustment weight(s) 6 is merely screwed into a relevant threaded hole(s) 5 of the flange portion 3. When vibration induced by high-speed rotation or vibration induced by machining is exerted on the tool holder 1, the tool holder 1 potentially involves a problem such that the adjustment weight(s) 6 is loosened and comes out of the threaded hole(s) 5 with long-term use.

### SUMMARY OF THE INVENTION

An object of the present invention is to provide a tool holder which allows reliable, low-cost implementation of coming-out prevention means for preventing detachment of a weight balance adjustment member.

According to a tool holder of the present invention, a weight balance adjustment member removably screwed into a threaded hole is prevented from coming out of the threaded hole by coming-out prevention means. Thus, detachment of the weight balance adjustment member can be reliably prevented, and the lock mechanism can be implemented at low cost.

According to a tool holder of the present invention, a plurality of threaded holes are formed at predetermined circumferential intervals on the outer circumferential surface of a flange portion in such a manner as to extend radially to a predetermined depth; balance adjustment members of the same length and the same mass are previously screwed into the threaded holes; and the adjustment member(s) is moved radially so as to adjust the tool holder to a condition free from rotational imbalance. Thus, there is no need to prepare various kinds of adjustment members of different lengths and masses, thereby facilitating storage management of adjustment members.

In the tool holder of the present invention, a detachment prevention member is provided on the outer circumferential surface of the flange portion, thereby preventing potential detachment of balance adjustment members from the threaded holes during use of the tool holder.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a partially sectional side view showing a conventional tool holder;

FIG. 2 is an end view viewed along line 2-2 of FIG. 1;

FIG. 3 is a longitudinal, partially sectional view of a tool holder having coming-out prevention means according to one embodiment of the present invention;

FIG. 4 is an end view viewed along line 4-4 of FIG. 3;

FIG. 5 is an enlarged sectional view of an adjustment member and a threaded hole portion in the embodiment of FIG. 3;

FIG. 6 is an enlarged sectional view of an adjustment member and a threaded hole portion in another embodiment of the present invention;

FIG. 7 is a side view of the adjustment member of FIG. 6;

FIG. 8 is an end view viewed along line 8-8 of FIG. 7;

FIG. 9 is a front view of an adjustment member in still another embodiment of the present invention;

FIG. 10 is a right-hand side view of the adjustment member of FIG. 9;

FIG. 11 is an explanatory view showing another manner of attachment in which the adjustment member having coming-out prevention means according to the present invention is attached to a flange portion of a tool holder;

FIG. 12 is an explanatory view showing still another manner of attachment in which the adjustment member having coming-out prevention means according to the present invention is attached to a connecting, stepped portion of a tool holder;

FIG. 13 is an explanatory view showing still another manner of attachment in which the adjustment member having coming-out prevention means according to the present invention is attached to a connecting, stepped portion of a tool holder;

FIG. 14 is a partially sectional side view of a tool holder according to still another embodiment of the present invention;

FIG. 15 is a side view of the adjustment member shown in FIG. 14;

FIG. 16 is an end view viewed along line 16-16 of FIG. 15; and

FIG. 17 is a perspective view of a detachment prevention member for preventing detachment of the adjustment members shown in FIG. 14.

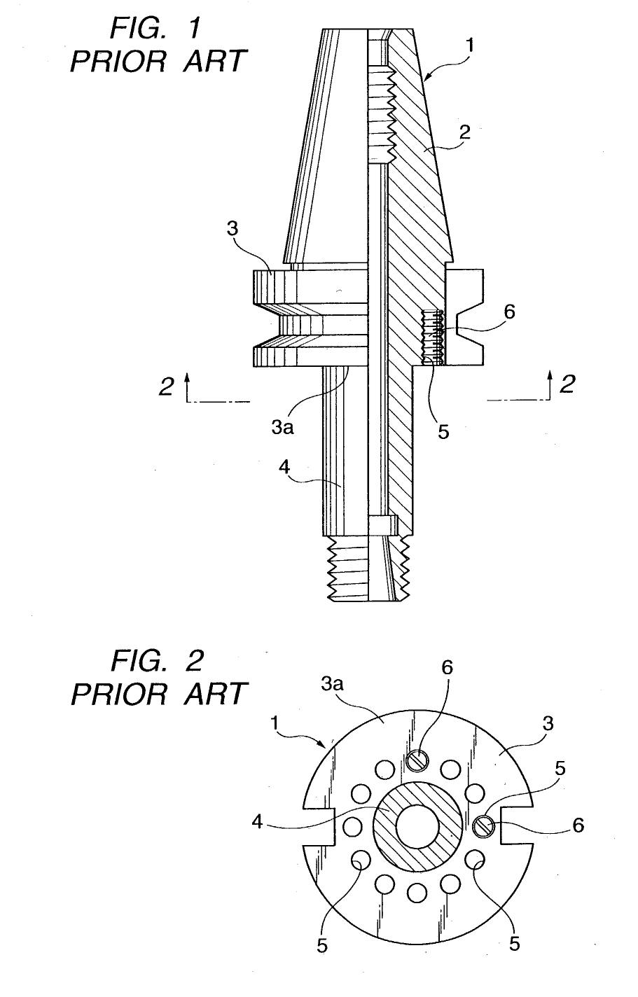

### DESCRIPTION OF THE PREFERRED EMBODIMENTS

Embodiments of the present invention will next be described in detail with reference to the drawings.

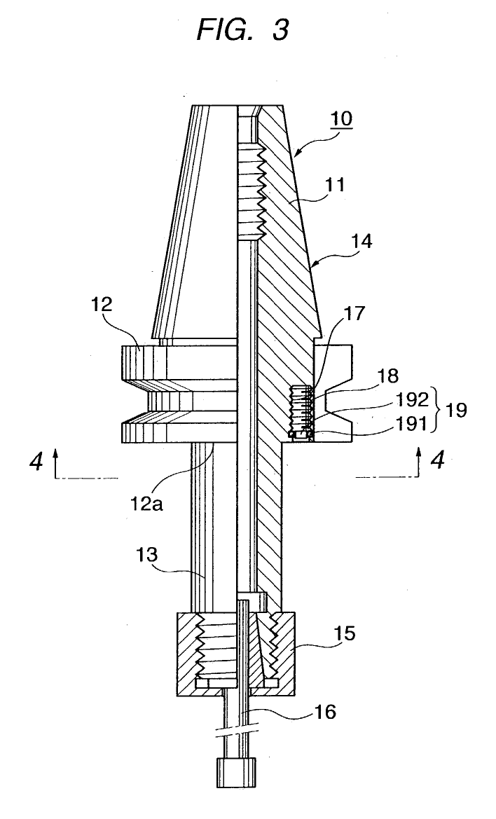

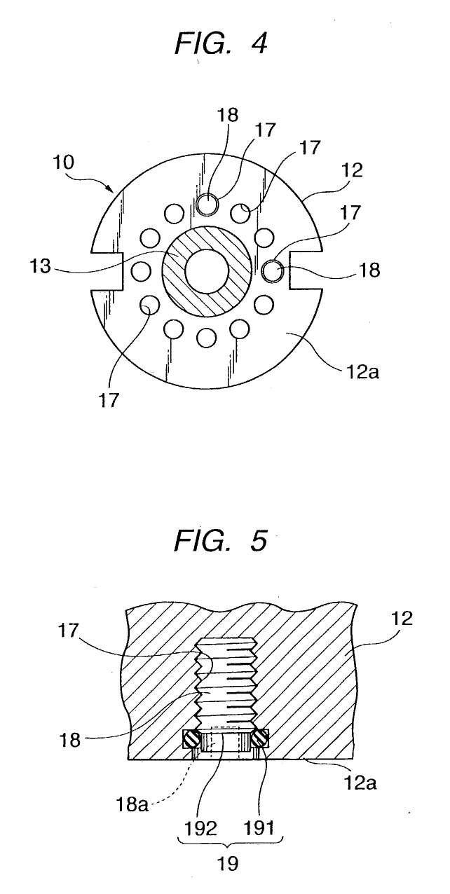

FIG. 3 is a longitudinal, partially sectional view of a tool holder having coming-out prevention means according to one embodiment of the present invention; FIG. 4 is an end view viewed along line 4-4 of FIG. 3; and FIG. 5 is an enlarged sectional view showing an adjustment member and a threaded hole portion in the present embodiment.

As shown in FIG. 3, a tool holder 10 includes a holder body 14 which in turn includes a tapered shank portion 11 to be attached to an unillustrated spindle of a machine tool; a flange portion 12 formed at a large-diameter end of the shank portion 11 and serving as a grip; and an arbor 13 (which serves as a tool attachment portion) formed integrally and coaxially on a side of the flange portion 12 opposite the shank portion 11. A cutting tool 16 such as a drill is attached to an end portion of the arbor 13 by means of a collet chuck 15.

As shown in FIGS. 3 and 4, a plurality of threaded holes 17 are formed at predetermined circumferential intervals on an end surface 12a of the flange portion 12 located on the side toward the arbor 13. The threaded holes 17 extend in parallel with the axis of the holder body 14 and assume a predetermined depth. Screw-type adjustment members 18 are removably screwed into selected appropriate threaded holes 17 so as to adjust rotational weight balance of the tool holder 10 associated with rotation of the tool holder 10 about its axis. Each of the adjustment members 18 has coming-out prevention means 19 for preventing the same from coming out of the threaded hole 17.

Various kinds of adjustment members 18 of different lengths and the same diameter are prepared such that weight differs slightly thereamong.

As shown in FIGS. 4 and 5, the lock mechanism 19 includes a ring member 191 such as an O-ring, and a stepped portion 192. The ring member 191 is provided on the inner circumferential surface of the threaded hole 17 in such a manner as to partially project toward the center of the threaded hole 17. The ring member 191 is formed from, for example, synthetic resin and is elastically deformable. The stepped portion 192 is formed on the outer circumferential surface of one end portion of the adjustment member 18. When the adjustment member 18 is screwed into the threaded hole 17, the stepped portion 192 is engaged with the ring member 191 so as to prevent detachment of the adjustment member 18.

A tool engagement hole 18a is formed on an end surface of the adjustment member 18 located opposite a leading end of the adjustment member 18 to be screwed into the threaded hole 18. The tool engagement hole 18a receives a tool for rotating the adjustment member 18 for attachment or detachment of the same.

In adjustment of the tool holder 10 of the above-described structure for rotational imbalance, the tool holder 10 is subjected to a balance test on a balancing machine. When any imbalance is involved, the balancing machine displays factors associated with the imbalance; specifically, excess mass, radius, and angle with respect to a reference position. On the basis of these values, the mass and attachment direction of the adjustment member(s) 18 are determined so as to correct the imbalance.

Then, the adjustment member(s) 18 of the above-obtained mass is selected and screwed into the threaded hole(s) 17 corresponding to the above-obtained direction. Since the stepped portion 192 of the adjustment member 18 screwed into the threaded hole 17 is engaged with the ring member 191 as shown in FIG. 5, the adjustment member 18 can be prevented from coming out of the threaded hole 17.

As described above, the tool holder 10 of the present embodiment is configured such that the stepped portion 192 of the adjustment member 18 screwed into the threaded hole 17 of the holder body 14 is engaged with the ring member 191 provided on the inner circumferential surface of the threaded hole 17 so as to prevent the adjustment member 18 from coming out of the threaded hole 17. Thus, even when vibration induced by high-speed rotation or vibration induced by machining is exerted on the holder body 14, the adjustment member 18 can be reliably prevented from coming out of the threaded hole 17. Prevention of detachment of the adjustment member 18 is implemented merely through provision of the ring member 191 such as an O-ring on the inner circumferential surface of the threaded hole 17 and thus can be implemented at low cost.

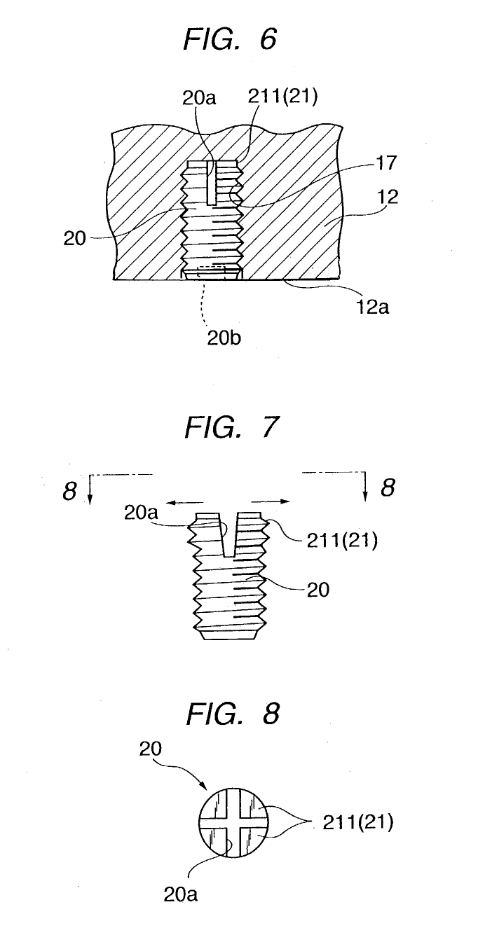

Next, coming-out prevention means for preventing detachment of an adjustment member from a tool holder according to another embodiment of the present invention will be described with reference to FIGS. 6 to 8.

FIG. 6 is an enlarged sectional view of an adjustment member and a threaded hole portion in the present embodiment; FIG. 7 is a side view of the adjustment member of FIG. 6; and FIG. 8 is an end view of the adjustment member of FIG. 7.

The adjustment member and the threaded hole portion shown in FIG. 6 will be described below, while structural features similar to those of FIG. 3 are denoted by common reference numerals. Threaded holes 17 similar to those of FIG. 3 are formed on the end surface 12a of the flange portion 12 located on the side toward the arbor 13. A screw-type adjustment member(s) 20 is removably screwed into a selected appropriate threaded hole(s) 17 so as to adjust rotational weight balance of the tool holder 10 associated with rotation of the tool holder 10. The adjustment member 20 has coming-out prevention means 21 for preventing the same from coming out of the threaded hole 17.

Various kinds of adjustment members 20 of different lengths and the same diameter are prepared such that weight differs slightly thereamong.

As shown in FIGS. 6 to 8, the lock mechanism 21 includes a plurality of elastic portions (in the present embodiment, four elastic portions) 211 formed on one end portion (a leading end portion to be screwed into the threaded hole 17) of the adjustment member 20. Specifically, a cross slit 20a is formed on the leading end surface of the adjustment member 20 in such a manner as to extend axially, thereby dividing the leading end portion of the adjustment member 20 into the elastic portions 211 along the circumferential direction. As shown in FIG. 7, the elastic portions 211 are radially spread beyond the diameter of the threaded hole 17.

A tool engagement hole 20b is formed on an end surface of the adjustment member 20 located opposite the leading end of the adjustment member 20 to be screwed into the threaded hole 17. The tool engagement hole 20b receives a tool for rotating the adjustment member 20 for attachment or detachment of the same.

When rotational weight balance of the tool holder 10 is to be adjusted by use of the adjustment member 20 having the lock mechanism 21, as in the case of the embodiment of FIG. 3, the tool holder 10 is subjected to a balance test on a balancing machine. When any imbalance is involved, on the basis of factors associated with the imbalance; specifically, excess mass, radius, and angle with respect to a reference position, the mass and attachment direction of the adjustment member(s) 20 are determined so as to correct the imbalance. Then, the adjustment member(s) 20 of the thus-obtained mass is selected, and is screwed into the threaded hole(s) 17 corresponding to the thus-obtained direction in such a manner that the lock mechanism 21 serves as a leading end for screwing. As a result of the screw engagement, the elastic portions 211 which are radially spread as shown in FIG. 7 are elastically squeezed radially inward to thereby come into close contact with the inner circumferential surface of the threaded hole 17.

Thus, according to the tool holder of the present embodiment, even when vibration induced by high-speed rotation or vibration induced by machining is exerted on the holder body, the adjustment member 20 can be reliably prevented from coming out of the threaded hole 17. Since the lock mechanism 21 for preventing detachment of the adjustment member 20 is formed such that the cross slit 20a is formed on one end surface of the adjustment member 20 to thereby divide the end portion into a plurality of elastic portions 211 along the circumferential direction, prevention of detachment of the adjustment member 20 can be implemented at low cost.

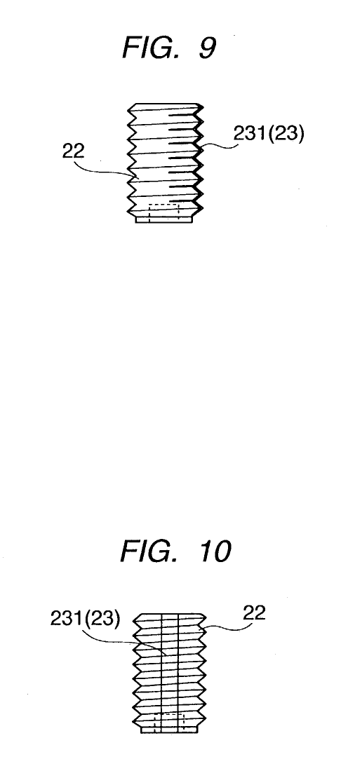

Next, coming-out prevention means for preventing detachment of an adjustment member from a tool holder according to still another embodiment of the present invention will be described with reference to FIGS. 9 and 10.

FIG. 9 is a front view of an adjustment member in the present embodiment; and FIG. 10 is a right-hand side view of the adjustment member of FIG. 9.

According to the present embodiment, coming-out prevention means 23 of an adjustment member 22 for adjusting weight balance of a tool holder includes a thin film layer 231 shown in FIGS. 9 and 10. The thin film layer 231 is formed in the following manner. Synthetic resin is applied to the outer circumferential surface of the screw-type adjustment member 22 in such a manner as to assume the form of a strip extending in parallel with the axis of the adjustment member 22. When the adjustment member 22 is screwed into a threaded hole, the thin film layer 231 partially fills the gap between the threaded hole and the adjustment member 22, thereby restraining rotation of the adjustment member 22.

Thus, according to the tool holder of the present embodiment, even when vibration induced by high-speed rotation or vibration induced by machining is exerted on the holder body, the adjustment member 22 can be reliably prevented from coming out of the threaded hole. Since the thin film layer 231 which partially constitutes the lock mechanism 23 can be formed merely through application of synthetic resin in the form of a strip to the outer circumferential surface of the adjustment member 22, prevention of detachment of the adjustment member 22 can be implemented at lower cost.

With regard to attachment of the adjustment member(s) 18 having coming-out prevention means to the flange portion 12, the present invention is not limited to that of FIG. 3 in which the adjustment member 18 extends in parallel with the axis of the arbor 13.

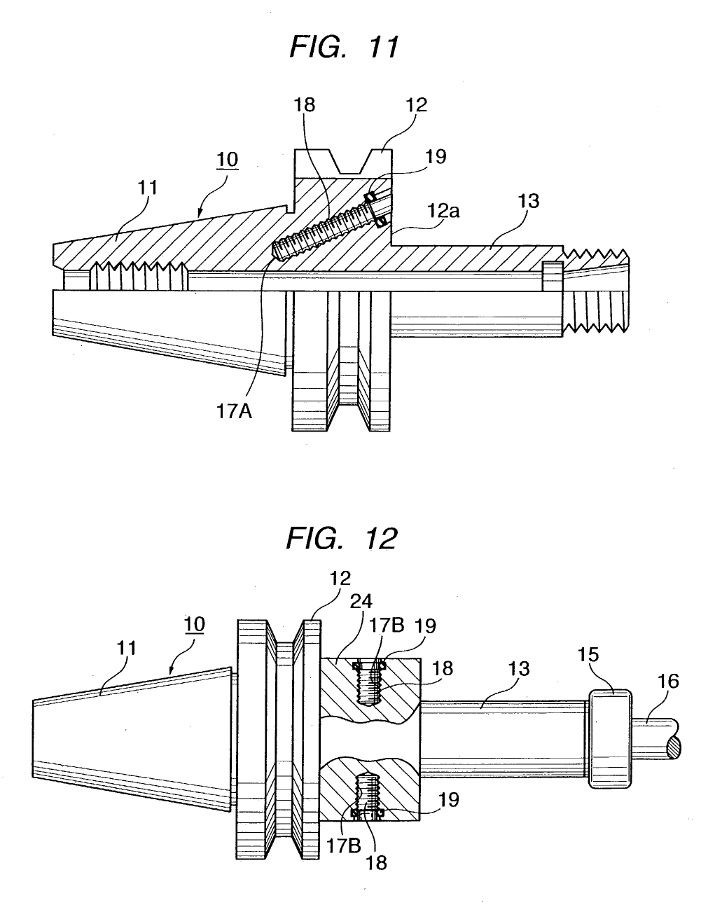

For example, attachment of the adjustment member(s) 18 may be as shown in FIG. 11. Specifically, threaded holes 17A are formed on the end surface 12a of the flange portion 12 in such a manner as to extend along respective directions that intersect with the axis of the arbor 13 at an acute angle. The adjustment member(s) 18 having the lock mechanism 19 is removably screwed into an appropriate threaded hole(s) 17A. Such attachment of the adjustment member(s) 18 yields action and effect similar to those which the embodiment of FIG. 3 yields.

In FIG. 11, structural features similar to those of FIG. 3 are denoted by common reference numerals.

With regard to attachment of the adjustment member(s) 18 having coming-out prevention means to the holder body 14, the present invention is not limited to that of FIG. 3 in which the adjustment member(s) 18 is attached to the flange portion 12.

For example, attachment of the adjustment member(s) 18 may be as shown in FIG. 12. Specifically, a plurality of threaded holes 17B are formed at predetermined circumferential intervals on the outer circumferential surface of a connecting, stepped portion 24 which connects the flange portion 12 and the arbor 13, in such a manner as to radially extend. The adjustment member(s) 18 having the lock mechanism 19 is removably screwed into an appropriate threaded hole(s) 17B. Such attachment of the adjustment member(s) 18 yields action and effect similar to those which the embodiment of FIG. 3 yields.

In FIG. 12, structural features similar to those of FIG. 3 are denoted by common reference numerals.

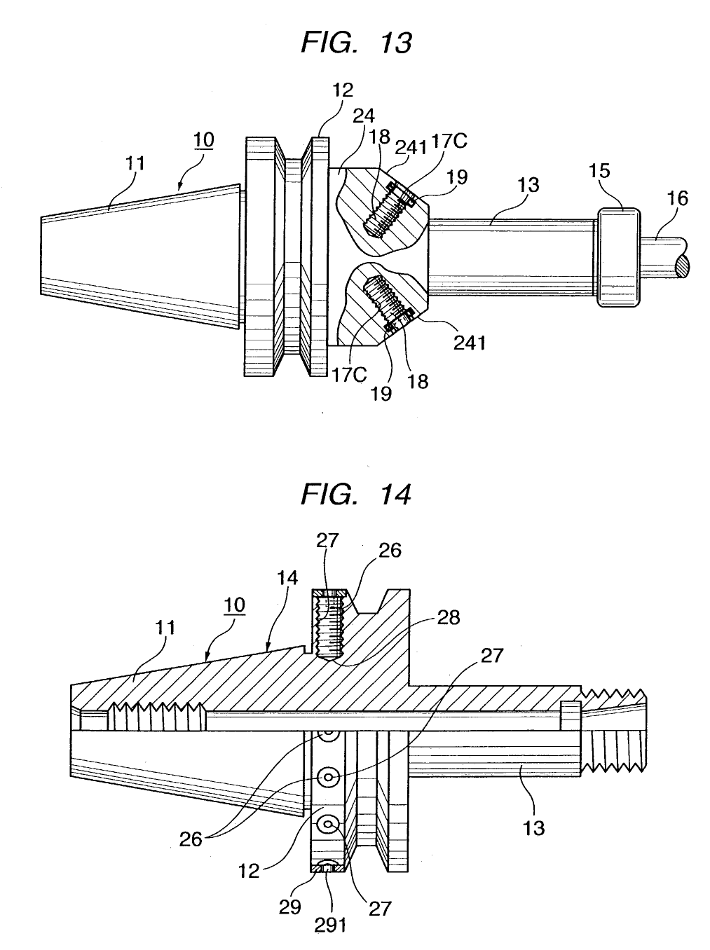

Alternatively, the adjustment member(s) 18 may be attached as shown in FIG. 13. An edge part of the connecting, stepped portion 24 which connects the flange portion 12 and the arbor 13 is obliquely cut off so as to form an inclined end surface 241. A plurality of threaded holes 17C are formed on the inclined end surface 241 in such a manner as to extend along respective directions that intersect with the axis of the connecting, stepped portion 24 at an acute angle and to be arranged at predetermined intervals on the same circle whose center is located on the axis of the connecting, stepped portion 24. The adjustment member(s) 18 having the lock mechanism 19 is removably screwed into an appropriate threaded hole(s) 17C. Such attachment of the adjustment member(s) 18 yields action and effect similar to those which the embodiment of FIG. 3 yields.

In FIG. 13, structural features similar to those of FIG. 3 are denoted by common reference numerals.

Next, a tool holder according to still another embodiment of the present invention will be described with reference to FIGS. 14 to 17.

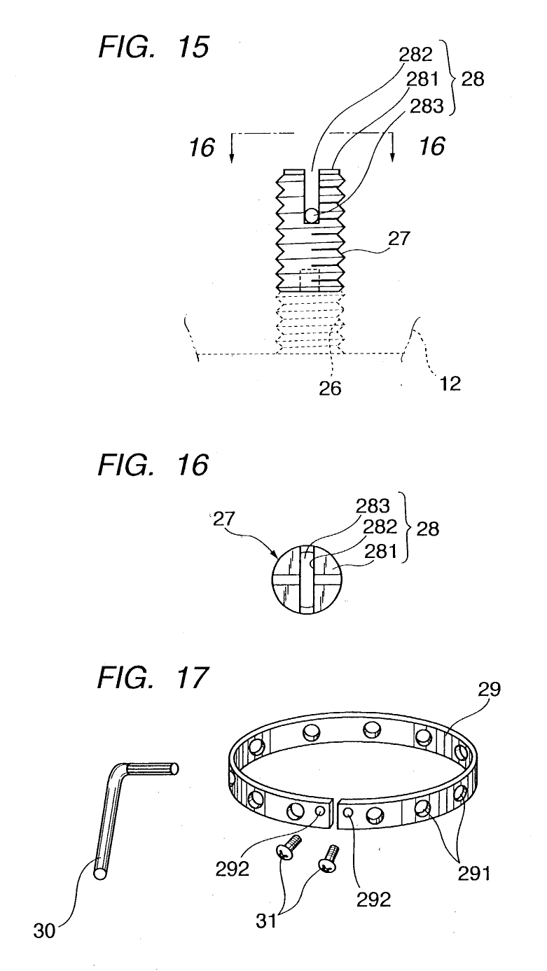

FIG. 14 is a partially sectional side view of the tool holder according to the present embodiment; FIG. 15 is a side view of the adjustment member shown in FIG. 14; FIG. 16 is an end view viewed along line 16-16 of FIG. 15; and FIG. 17 is a perspective view showing a detachment prevention member for preventing detachment of the adjustment members shown in FIG. 14.

In FIG. 14 showing a tool holder 10, structural features similar to those of FIG. 3 are denoted by common reference numerals, and repeated description thereof is omitted. Description below focuses on structural features that differ from those of FIG. 3.

The tool holder 10 of FIG. 14 differs from that of FIG. 3 in the following: a plurality of threaded holes 26 are formed at predetermined circumferential intervals on the outer circumferential surface of a flange portion 12 in such a manner as to extend radially to a predetermined depth; and balance adjustment members 27 which are sufficiently shorter than the depth of the threaded holes 26 are screwed into the threaded holes 26 such that position thereof is adjustable along a radial direction of the flange portion 12. The adjustment members 27 are adapted to adjust rotational weight balance of the holder body, and each have coming-out prevention means 28 for preventing the same from coming out of the corresponding threaded hole 26.

Notably, the adjustment members 27 used in the present embodiment assume the same length and the same mass.

As shown in FIGS. 15 and 16, the lock mechanism 28 includes an insert member 283 and a plurality of elastic portions 281 formed through circumferentially dividing one end portion of the adjustment member 27. The insert member 283 is made of a metal material resembling a round bar or an elastic metal material and is fitted into a gap 282 between the elastic portions 281 so as to spread the elastic portions 281 beyond the diameter of the threaded hole 26.

As shown in FIG. 14, a detachment prevention member 29 for preventing detachment of the adjustment members 27 from the threaded holes 26 is provided on the outer circumferential surface of the flange portion 12 where the threaded holes 26 are formed.

As shown in FIG. 17, the detachment prevention member 29 is formed in the following manner: a narrow metal plate material is formed into the shape of a ring which fits the outside diameter of the flange portion 12. Tool insertion holes 291 are formed in the detachment prevention member 29 at positions which face the corresponding threaded holes 26, in order to allow insertion of a tool 30 for adjusting the position of the adjustment member 27 screwed in the threaded hole 26, along a radial direction of the flange portion 12. The detachment prevention member 29 is fixedly attached to the outer circumference of the flange portion 12 by means of clamp screws 31 inserted through respective mounting holes 292 which are formed at opposite end portions of the detachment prevention member 29.

In adjustment of the tool holder 10 of the above-described structure for rotational imbalance, the adjustment members 27 each having the lock mechanism 28 are screwed into the threaded holes 26, for example, in such a manner as to reach the respective bottoms of the threaded holes 26. Furthermore, the detachment prevention member 29 is fixedly attached to the flange portion 12. In this state, as in the case of the embodiment of FIG. 3, the tool holder 10 is subjected to a balance test on a balancing machine. When any imbalance is involved, on the basis of factors associated with the imbalance; specifically, excess mass, radius, and angle with respect to a reference position, the mass and attachment direction of the adjustment member(s) 27 are determined so as to correct the imbalance. The adjustment member(s) 27 corresponding to the thus-obtained direction is rotated so as to be moved in a radial direction of the flange portion 12, by use of the tool 30 inserted through the corresponding tool insertion hole 291 of the detachment prevention member 29, whereby the tool holder 10 is adjusted to a condition free from rotational imbalance.

Thus, according to the tool holder 10 of the present embodiment, even when vibration induced by high-speed rotation or vibration induced by machining is exerted on the holder body 14, the adjustment members 27 can be reliably prevented from coming out of the threaded holes 26. Since the insert member 283 and the elastic portions 281 formed at one end portion of the adjustment member 27 constitute the lock mechanism 28, prevention of detachment of the adjustment members 22 can be implemented at lower cost.

According to the present embodiment, the adjustment members 27 of the same length and the same mass are previously screwed into the threaded holes 26, and the adjustment member(s) is moved radially so as to adjust the tool holder 10 to a condition free from rotational imbalance. Thus, there is no need to prepare various kinds of adjustment members 27 of different lengths and masses, thereby facilitating storage management of the adjustment members 27.

According to the present embodiment, the detachment prevention member 29 is provided on the outer circumferential surface of the flange portion 12, thereby preventing potential detachment of the adjustment members 27 screwed into the threaded holes 26 during use of the tool holder 10.

The embodiment shown in FIG. 14 is described while mentioning the case where the adjustment members 27 of the same length and the same mass are screwed into all of the threaded holes 26, respectively. However, the present invention is not limited thereto. For example, an adjustment member(s) similar to that shown in FIG. 3 may be screwed into an appropriate threaded hole(s) as in the case of FIG. 3.

Obviously, numerous modifications and variations of the present invention are possible in light of the above teachings. It is therefore to be understood that within the scope of the appended claims, the present invention may be practiced otherwise than as specifically described herein.

What is claimed is:

1. A tool holder comprising a holder body, the holder body comprising a shank portion and a tool attachment portion provided coaxially and integrally at one end of the shank portion;
wherein a plurality of threaded holes each assuming a predetermined depth are formed on the holder body excluding the shank portion, at predetermined intervals along a circumferential direction of the holder body, and an adjustment member for adjusting rotational weight balance of the holder body is screwed into an arbitrary threaded hole among the threaded holes; and
the adjustment member comprises coming-out prevention means for preventing the adjustment member from coming out of the threaded hole.

2. A tool holder according to claim 1, wherein the threaded holes are formed in the holder body in such a manner as to extend along a direction perpendicular to, a direction in parallel with, or a direction inclined with respect to an axis of the holder body.

3. A tool holder according to claim 1, wherein the holder body comprises a flange portion formed at a large-diameter end of the shank portion and serving as a grip, and the threaded holes are formed on an end surface of the flange portion in such a manner as to extend in parallel with an axis of the holder body and to be arranged at predetermined intervals on the same circle whose center is located on an axis of the flange portion.

4. A tool holder according to claim 1, wherein the holder body comprises a flange portion formed at a large-diameter end of the shank portion and serving as a grip, and the threaded holes are formed on an outer circumferential surface of the flange portion in such a manner as to extend radially and to be arranged at predetermined intervals along a circumferential direction of the flange portion.

5. A tool holder according to claim 1, wherein the lock mechanism comprises an elastically deformable ring member which is provided on an inner circumferential surface of the threaded hole in such a manner as to partially project toward a center of the threaded hole, and a stepped portion which is formed on an outer circumferential surface of one end portion of the adjustment member and which is engaged with the ring member when the adjustment member is screwed into the threaded hole, to thereby prevent detachment of the adjustment member.

6. A tool holder according to claim 1, wherein the lock mechanism comprises a plurality of elastic portions which are formed at one end portion of the adjustment member through division of the end portion along a circumferential direction of the end portion, and the elastic portions are radially spread beyond a diameter of the threaded hole.

7. A tool holder according to claim 1, wherein the lock mechanism comprises a thin-film layer which is formed on an outer circumferential surface of the adjustment member in parallel with an axis of the adjustment member and which partially fills a gap between the threaded hole and the adjustment member screwed into the threaded hole to thereby restrain rotation of the adjustment member.

8. A tool holder according to claim 1, wherein a tool engagement hole which receives a tool for rotating the adjustment member for attachment or detachment of the adjustment member is formed on an end surface of the adjustment member located opposite a leading end of the adjustment member to be screwed into the threaded hole.

9. A tool holder comprising a holder body, the holder body comprising a shank portion, a tool attachment portion provided coaxially and integrally at one end of the shank portion, and a flange portion formed between the shank portion and the tool attachment portion and serving as a grip;
wherein a plurality of threaded holes are formed on an outer circumferential surface of the flange portion in such a manner as to extend radially to a predetermined depth and to be arranged at predetermined intervals along a circumferential direction of the flange portion, and adjustment members which are shorter than the depth of the threaded holes and adapted to adjust rotational weight balance of the holder body are screwed into the threaded holes such that position of each of the adjustment members is adjustable along a radial direction of the flange portion; and
each of the adjustment members has coming-out prevention means for preventing the adjustment member from coming out of the corresponding threaded hole.

10. A tool holder according to claim 9, wherein a detachment prevention member for preventing detachment of the adjustment members from the threaded holes is provided on the outer circumferential surface of the flange portion where the threaded holes are formed.

11. A tool holder according to claim 10, wherein tool insertion holes are formed in the detachment prevention member at positions which face the corresponding threaded holes, in order to allow insertion of a tool for adjusting a position of the adjustment member screwed in the threaded hole, along a radial direction of the flange portion.

12. A tool holder according to claim 9, wherein the lock mechanism comprises a plurality of elastic portions which are formed at one end portion of each of the adjustment members through division of the end portion along a circumferential direction of the end portion, and a member which is fitted into a gap between the elastic portions so as to spread the elastic portions beyond a diameter of the threaded hole.
